(19) United States
(12) Patent Application Publication
(10) Pub. No.: US 2019/0203789 A1
(43) Pub. Date: Jul. 4, 2019

(54) BRAKE DISC

(71) Applicant: YONG THYE NG, SUNGAI MATI (MY)

(72) Inventor: YONG THYE NG, SUNGAI MATI (MY)

(21) Appl. No.: 16/326,875

(22) PCT Filed: Sep. 21, 2017
(86) PCT No.: PCT/MY2017/050058

§ 371 Date: Feb. 20, 2019

(30) Foreign Application Priority Data
Dec. 22, 2016 (MY) PI 2016704765

(51) Int. Cl. F16D 65/12; F16D 65/00

(52) U.S. Cl. CPC F16D 65/127; F16D 2065/1324; F16D 65/0006

(57) ABSTRACT

This disclosure describes a brake disc of a disc brake assembly applied in braking system of transportation, machines, wind turbines and propellers. The brake disc comprises a body defined by a flat annular member (101) having an outboard surface integrated with a protruding flange (102) and an inboard surface. The flat annular member (101) is formed with a plurality of friction portions (103) made of friction materials with surfaces that are substantially at the same level as the surfaces of the flat annular member (101) for reducing vibration of the brake disc when brake pads are compressed against the brake disc to improve performance of the braking system.

### FIELD OF INVENTION

This disclosure relates to a brake disc which is a component in a disc brake of a brake system.

### BACKGROUND OF THE INVENTION

Disc brake is an important brake assembly in a brake system used commonly for decelerating and eventually stopping movement of rotating assemblies in propellers, machines, turbines and transportation such as military vehicles and equipment, forklift, car truck, train, aeroplane and submarine. The disc brake comprises a brake disc, a brake caliper and brake pads. Upon exerting force to compress the piston with brake hydraulic fluid within the brake caliper, pressure is applied to the brake pads such that they are squeezed against the brake disc, thereby generating friction to retard rotation of the rotating assembly.

The invention disclosed herein focuses on the brake disc which is a rotor in the disc brake. Prior art US20020139622A1 discloses a rotor disk which is a brake disc for car disc brake. Components of this brake disc includes a rotor disk and a fastening hub. The rotor disk has an opening in the center, a reinforced ring surrounding the opening and a plurality of screw bores formed in the reinforced ring. The fastening hub has a flange which has multiple screw bores engageable with the screw bores of the rotor disk. These features of this brake disc allow the flange to engage closely with the reinforced ring for improving the strength of total structure to bear greater stress for the purpose of enhancing stability and safety. The design of this brake disc is also compatible for different car models.

Through applying friction surface indent patterns on the brake disc, prior art U.S. Pat. No. 8,146,719B2 claims to enhance the surface wear characteristics of brake pad friction surfaces of brake disc to reduce the radial taper wear of the brake pad friction surfaces. The indent patterns are in the form of radial-biased grooves or linearly arranged cross-drill hole sets. Configuration of the indent patterns depends on the type of brake calliper and brake pad material to achieve even brake pad wear and improve the brake feel of the brake system.

While prior art US20020139622A1 pays attention to the engagement of brake disc to the wheel and prior art U.S. Pat. No. 8,146,719B2 emphasizes on prolonging durability of brake pad through the formation of indent patterns on the brake disc, both prior arts lack information on the utilization of the brake disc to improve braking performance of the disc brake. Therefore, the invention disclosed herein aims to provide solutions in enhancing braking performance through the brake disc.

### SUMMARY OF INVENTION

An aspect of this invention is to provide a brake disc of a disc brake that is integrated with friction materials.

Another aspect of this invention is to provide a brake disc with friction portions made of friction material on its flat annular member that have surfaces at the same level as the surfaces of the flat annular member.

Still another aspect of this invention is to provide a brake disc that enhances performance of the braking system.

Yet another aspect of this invention is to provide a brake disc that reduces vibration of the disc brake when the brake pad is compressed against the brake disc to create a braking torque for hindering rotation of the rotating assembly.

Also another aspect of this invention is to provide a brake disc adaptable to disc brakes of any transportation, machine, wind turbine and propeller systems with rotating assemblies.

At least one of the preceding aspects is met, in whole or in part, by this invention, in which the preferred embodiment of this invention describes a brake disc comprising a body defined by a flat annular member having an outboard surface integrated with a protruding flange and a inboard surface; wherein the flat annular member is formed with a plurality of friction portions made of friction materials with surfaces that are substantially at the same level as the surfaces of the flat annular member.

### BRIEF DESCRIPTION OF THE DRAWINGS

FIG. 1 shows a first preferred embodiment of the invention with swirling radial patterned friction portions.

FIG. 2 shows a second preferred embodiments of the invention with friction portions in the form of a check pattern.

FIG. 3 shows a third preferred embodiment of the invention with friction portions in the form of randomly distributed circles.

FIG. 4 shows a forth preferred embodiment of the invention with a friction portion in the form of a circular border surrounding the protruding flange of the brake disc.

FIG. 5 shows a fifth preferred embodiment of the invention with a friction portion of a logo design whereby the protruding flange is not depicted in this figure.

FIG. 6 shows a sixth preferred embodiment of the invention with friction portions formed of characters.

### DETAILED DESCRIPTION OF THE INVENTION

For a better understanding of the invention, preferred embodiments of the invention that are illustrated in the accompanying drawings will be described in detail.

The invention disclosed herein pertains to a brake disc which is also known as a rotor in a disc brake assembly of a braking system for transportations, machines and propellers with rotating assemblies such as turbines, military vehicles and equipment, forklift, car truck, train, aeroplane and submarine. The brake disc is connected to the rotating assembly such that it is rotatable at the same speed as the rotating assembly. For instance, the brake disc in a vehicle is connected to the axel of the vehicle so that it can rotate at the same velocity as the wheel. In disc brake applications, brake pads are held in position to face the brake disc and are actuated by a caliper affixed to a rotating component such as a wheel hub of a vehicle or a rotor in a machine. In this disclosure, the ‘rotating component’ refers to the rotary part of a rotating assembly in a transportation, propeller, wind turbine, machine and the like.

Based on a preferred embodiment of the invention, the brake disc is a solid brake disc applied generally at rear brakes and for light duty applications. However, it is to be understood that the solid brake disc is not limited to rear brake application. It has a body defined by a flat annular member (101) having an obverse surface defining an outboard surface, and a reverse surface being an inboard surface, in which the outboard surface is integrated with a protruding flange (102) at the opening of the flat annular member. The protruding part of the flange (102) that joins the flange (102) with the flat annular member (101) defines a rotor hat. Both outboard and inboard surfaces of the flat annular member (101) are subject to be in contact with the brake pads when the brake pads are compressed thereon. The protruding flange (102) has a center opening (104). Apertures (105) are formed around the center opening (104) to receive fasteners for installations of a rotating component such as a vehicle wheel in which the flange (102) is slid on and bolted to a wheel hub. A rotor of a machine and a rotating hub of a propeller can also be considered as a rotating component.

However, the brake disc of this invention can also be a vented brake disc which is applicable in front and rear brakes through incorporating a vent assembly at the inbound surface of the flat annular member (101). The vent assembly includes a flat ring and a set of vents connected in between the flat annular member and the flat ring for circulating air to dissipate heat. The flat ring is basically similar as the flat annular member (101), whereby the flat ring has a substantially similar dimension and shape as the flat annular member (101). The obverse surface of the flat ring is connected to the vents, whereas the reverse surface of the flat ring has no vents joined thereto. For a vented brake disc, the ‘outbound surface of the brake disc’ refers to the obverse surface of the flat annular member (101), whereas the ‘inbound surface of the brake disc’ indicates the reverse surface of the flat ring. On the other hand, for a solid brake disc, the ‘outbound surface of the brake disc’ is the obverse surface of the flat annular member (101), whereas the ‘inbound surface of the brake disc’ refers to the reverse surface of the flat annular member (101). The flat ring is formed with a plurality of friction portions (103) made of friction materials with surfaces that are substantially at the same level as the surfaces of the flat ring.

The brake disc excluding the friction portions (103) can be made of any materials such as but not limited to cast iron, steel, zinc, phosphorus, nodular graphite, reinforced carbon-carbon or ceramic matrix composites. On the other hand, the friction materials that form the friction portions (103) on the brake disc include but not limited to any one or combination of carbon ceramic, asbestos, semi-metallic, non-asbestos organic and low steel. The built-in friction materials in the disc brake provide a rough surface for generating frictions to decelerate the movement of the rotating component.

The main feature of this invention is the friction portions (103) of the brake disc having flat surfaces such that they are in the same level as the surfaces of the flat annular member (101) and the flat ring. Such feature reduces vibration of the brake disc during operation of the brake system when the brake pads are compressed against the brake disc by the brake caliper upon the exertion of hydraulic pressure. The reduction of vibration improves braking effects and thus enhances the performance of the braking system.

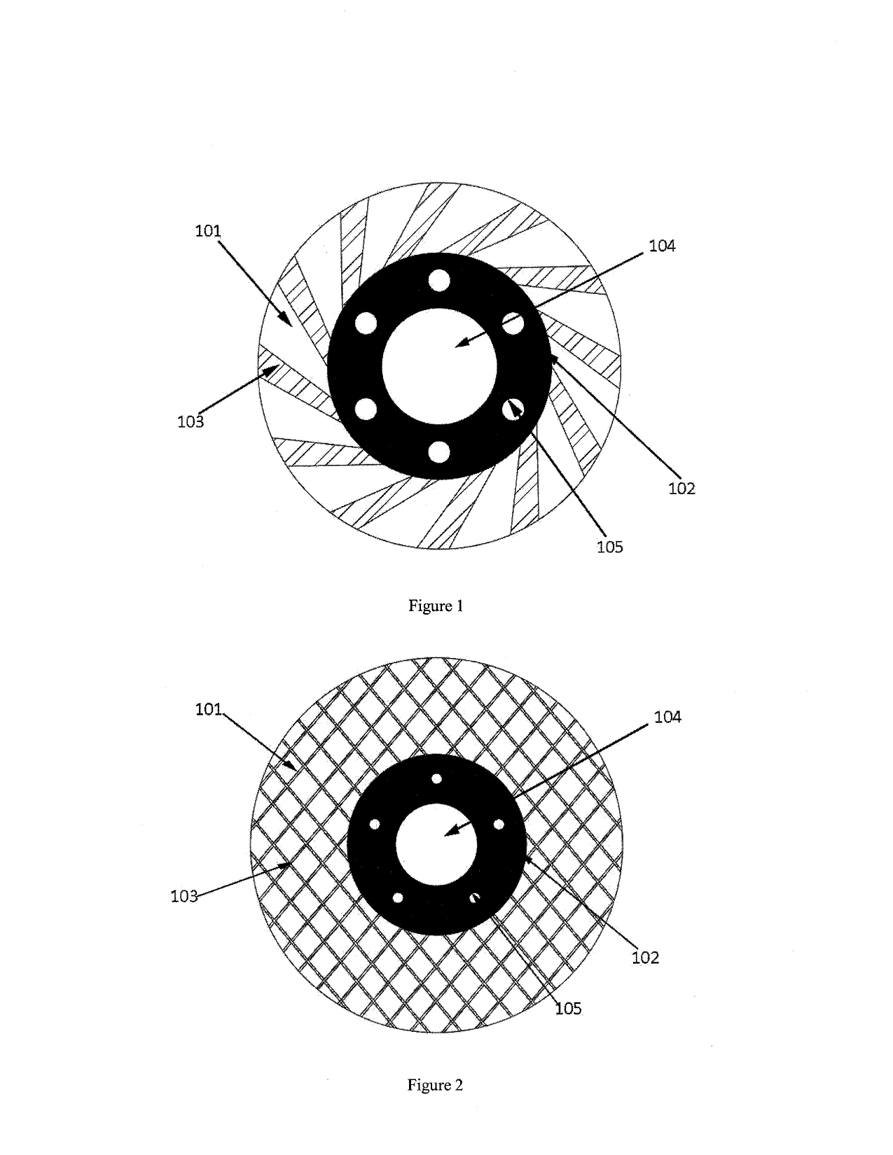

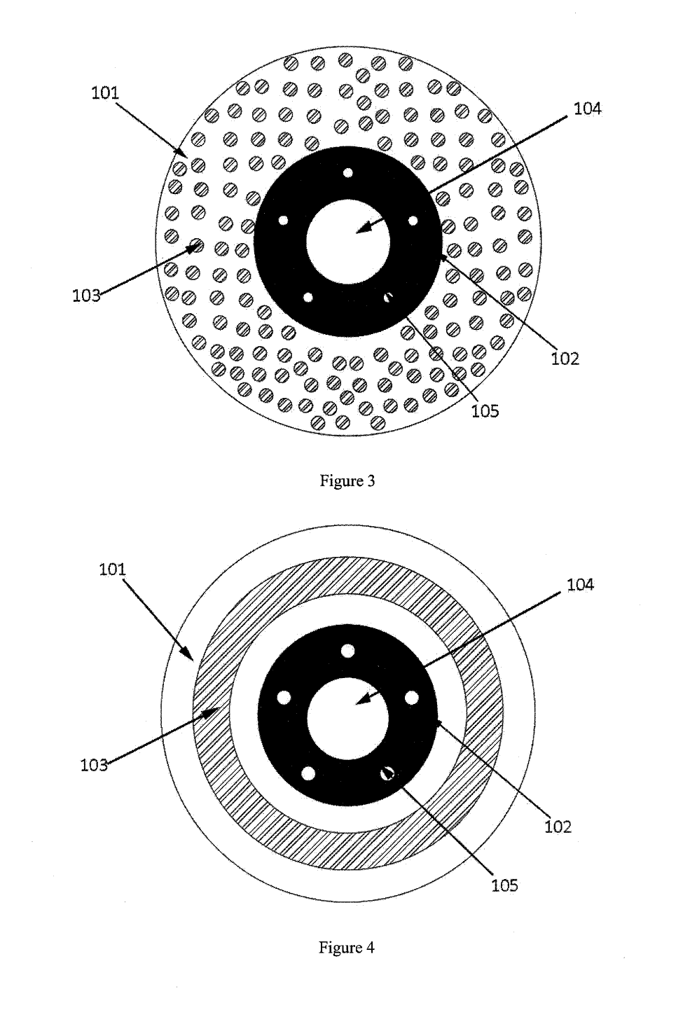

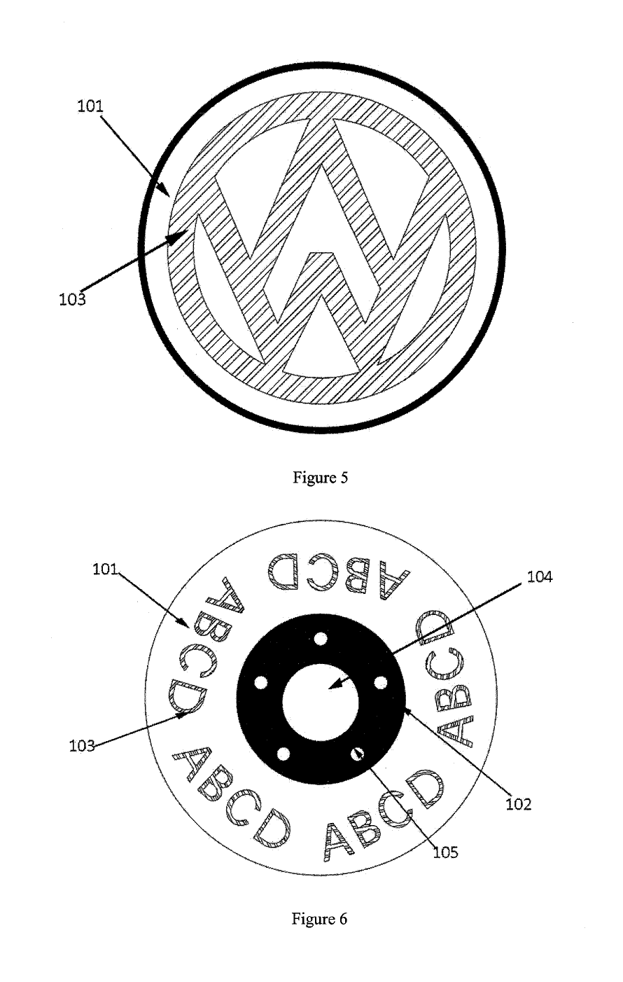

This invention allows various configuration for the friction portion (103) including a pattern or a non-recurring design. Examples of patterned design for the friction portions (103) include swirling radial pattern as shown in FIG. 1 and check pattern as illustrated in FIG. 2. The friction portions (103) in FIG. 3 is in the form of randomly distributed circles. Other exemplary embodiments of the invention with non-recurring designs are shown in FIG. 4 and FIG. 5 respectively. FIG. 4 presents a circular boarder as the friction portion (103) that surrounds the protruding flange (102) of the brake disc whereas FIG. 5 depicts a logo design as the friction portion (103). In FIG. 5, the protruding flange (102) is not included in the figure. On the other hand, characters can also be applied as a form of the friction portions (103). The example in FIG. 6 exhibits repeated strings of characters as a pattern of the friction portions (103). Both the logo and characters design can be used as a brand indication of the brake disc or the transportation, machine, turbine or propeller.

While the invention has been described and illustrated with reference to certain exemplary embodiments thereof, the scope of the invention is not intended to be, nor should it be deemed to be, limited thereby and such other modifications or embodiments as may be suggested by the teachings herein are particularly reserved especially as they fall within the scope of the claims here appended.

1.-8. (canceled)

9. A brake disc, comprising:
a body defined by a flat annular member having an outboard surface integrated with a protruding flange and an inboard surface;
wherein the flat annular member is formed with a plurality of friction portions made of friction materials with surfaces that are substantially at the same level as the surfaces of the flat annular member.

10. The brake disc according to claim 9, wherein the friction materials include any one or combination of carbon ceramic, asbestos, semi-metallic, non-asbestos organic and low steel.

11. The brake disc according to claim 9, wherein the friction portions have a configuration of any one or a combination of a pattern or a non-recurring design.

12. The brake disc according to claim 9, wherein the protruding flange has a center opening.

13. The brake disc according to claim 9, wherein the protruding flange is fabricated with one or more apertures to receive fasteners for installations of a rotating component.

14. The brake disc according to claim 13, wherein the rotating component is a wheel, a rotor or a rotating hub.

15. The brake disc according to claim 9, wherein the brake disc excluding the friction portions is made of cast iron, steel, zinc, phosphorus, nodular graphite, reinforced carbon-carbon or ceramic matrix composites.

16. The brake disc according to claim 9, further comprising a vent assembly connected to the inboard surface of the flat annular member including a flat ring having a substantially similar dimension and shape as the flat annular member, and a set of vents connected in between the flat annular member and the flat ring, wherein the flat ring is formed with a plurality of friction portions made of friction materials with surfaces that are substantially at the same level as the surfaces of the flat ring.
